(19) United States
(12) Patent Application Publication
(10) Pub. No.: US 2024/0405217 A1
(43) Pub. Date: Dec. 5, 2024

(54) LITHIUM IRON PHOSPHATE POSITIVE ELECTRODE ACTIVE MATERIAL, POSITIVE ELECTRODE SHEET AND LITHIUM ION BATTERY

(71) Applicant: BYD COMPANY LIMITED, SHENZHEN (CN)

(72) Inventors: Jiamin LIU, Shenzhen (CN); Sanzhi CHEN, Shenzhen (CN); Qingqing GAO, Shenzhen (CN); Rong HAO, Shenzhen (CN)

(21) Appl. No.: 18/802,786

(22) Filed: Aug. 13, 2024

Related U.S. Application Data
(63) Continuation of application No. PCT/CN2023/074706, filed on Feb. 7, 2023.

(30) Foreign Application Priority Data
Feb. 15, 2022 (CN) 202210139348.3

(51) Int. Cl. H01M 4/58; C01B 25/45; H01M 4/02; H01M 4/136; H01M 4/36; H01M 4/62; H01M 10/0525

(52) U.S. Cl. CPC H01M 4/5825; C01B 25/45; H01M 4/136; H01M 4/366; H01M 4/625; H01M 10/0525; C01P 2004/61; C01P 2006/10; C01P 2006/40; H01M 2004/028

(57) ABSTRACT

A lithium iron phosphate positive electrode active material includes: a first lithium iron phosphate material having a particle size of D¹ᵥ50 μm in a range of 0.3-0.95 at 50% cumulative volume distribution of the first lithium iron phosphate material, and a second lithium iron phosphate material having a particle size of D²ᵥ50 μm in a range of 1.0-3.5 at 50% cumulative volume distribution of the second lithium iron phosphate material. Particle sizes of the lithium iron phosphate positive electrode active material are respectively Dᵥ90 μm, Dᵥ10 μm, and Dᵥ50 μm at 90%, 10%, and 50% cumulative volume distribution of the lithium iron phosphate positive electrode active material, a particle size of the lithium iron phosphate positive electrode active material is Dₙ50 μm at 50% cumulative number distribution of the lithium iron phosphate positive electrode active material, and

$$0.16 \leq \frac{{D}_{v} 90 - {D}_{v} 10}{{D}_{v} 50} + {D}_{v} 50 \times {D}_{n} 50 \leq 31.1 .$$

### CROSS-REFERENCE TO RELATED APPLICATIONS

This application is a continuation application of International Patent Application No. PCT/CN2023/074706, filed on Feb. 7, 2023, which is based on and claims priority to and benefits of Chinese Patent Application No. 202210139348.3 filed on Feb. 15, 2022. The entire content of all of the above-referenced applications is incorporated herein by reference.

### FIELD

The present disclosure relates to the field of lithium ion batteries, and particularly to a lithium iron phosphate positive electrode active material, a positive electrode sheet, and a lithium ion battery.

### BACKGROUND

Lithium iron phosphate material has wide use due to the high safety, low cost, environmental friendliness and other advantages. However, the lithium iron phosphate material also has obvious defects. That is, the compaction density of the lithium iron phosphate material is low, which leads to the low energy density of batteries prepared with the lithium iron phosphate material, so the demand for batteries with long battery life cannot be met. To improve the energy density of the battery, a lithium iron phosphate material having a high compaction density is needed. However, when the compaction density of the lithium iron phosphate material is increased, the electrochemical performance of the battery is often reduced.

### SUMMARY

In a first aspect, the present disclosure provides a lithium iron phosphate positive electrode active material, which includes: a first lithium iron phosphate material and a second lithium iron phosphate material. A particle size of the first lithium iron phosphate material is D¹ᵥ50 μm at 50% cumulative volume distribution of the first lithium iron phosphate material, a particle size of the second lithium iron phosphate material is D²ᵥ50 μm at 50% cumulative volume distribution of the second lithium iron phosphate material, D¹ᵥ50 is in a range of 0.3-0.95, and D²ᵥ50 is in a range of 1.0-3.5. Particle sizes of the lithium iron phosphate positive electrode active material are respectively Dᵥ90 μm, Dᵥ10 μm, and Dᵥ50 μm at 90%, 10%, and 50% cumulative volume distribution of the lithium iron phosphate positive electrode active material, a particle size of the lithium iron phosphate positive electrode active material is Dₙ50 μm at 50% cumulative number distribution of the lithium iron phosphate positive electrode active material, and Dᵥ90, Dᵥ10, and Dᵥ50, and Dₙ50 meet:

$$0.16 \leq \frac{{D}_{v} 90 - {D}_{v} 10}{{D}_{v} 50} + {D}_{v} 50 \times {D}_{n} 50 \leq 31.1 .$$

In some embodiments of the present disclosure, the maximum compaction density is 2.55-2.85 g/cm³.

In some embodiments of the present disclosure, D¹ᵥ50 of the first lithium iron phosphate material is in the range of 0.4-0.85, and D²ᵥ50 of the second lithium iron phosphate material is in the range of 1.2-3.0.

In some embodiments of the present disclosure, Dᵥ90, Dᵥ10, Dᵥ50, and Dₙ50 meet:

$$0.2 \leq \frac{{D}_{v} 90 - {D}_{v} 10}{{D}_{v} 50} + {D}_{v} 50 \times {D}_{n} 50 \leq 31.$$

In some embodiments of the present disclosure, Dᵥ50×Dₙ50 is in the range of 0.05-4.9.

In some embodiments of the present disclosure, Dᵥ50 of the lithium iron phosphate positive electrode active material is in the range of 0.25-3.5.

In some embodiments of the present disclosure, the mixing weight ratio of the first lithium iron phosphate material and the second lithium iron phosphate material is in the range of 1:(1-9).

In some embodiments of the present disclosure, at least one surface of the first lithium iron phosphate material and the second lithium iron phosphate material has a carbon coating layer.

In a second aspect, the present disclosure provides a positive electrode sheet. The positive electrode sheet includes a lithium iron phosphate positive electrode active material according to the first aspect of the present disclosure.

In some embodiments of the present disclosure, the positive electrode sheet includes a positive electrode current collector and a positive electrode active material layer disposed on a surface of the positive electrode current collector. The positive electrode active material layer includes the lithium iron phosphate positive electrode active material, a binder, and a conductive agent.

In some embodiments of the present disclosure, the positive electrode active material layer is formed by coating a positive electrode paste including the lithium iron phosphate positive electrode active material, the conductive agent, the binder and a solvent on the positive electrode current collector.

In a third aspect, the present disclosure provides a lithium ion battery. The lithium ion battery includes a positive electrode sheet according to the second aspect of the present disclosure.

In some embodiments of the present disclosure, the lithium ion battery further includes a negative electrode sheet, and an electrolyte solution, and a separator between the positive electrode sheet and the negative electrode sheet.

### BRIEF DESCRIPTION OF THE DRAWINGS

FIG. 1 shows a cycle performance curve of each pouch battery in Example/Embodiments 1 to 5 and Comparative Example/Embodiment 1 of the present disclosure.

### DETAILED DESCRIPTION

The foregoing descriptions are some implementations of the present disclosure. It should be noted that several modifications and variations can be made by those of ordinary skill in the art without departing from the principle of the present disclosure, which shall fall within the protection scope of the present disclosure.

The present disclosure provides a lithium iron phosphate positive electrode active material, which has an increased compaction density, and enables a battery prepared therewith to have good electrochemical performances.

In a first aspect, the present disclosure provides a lithium iron phosphate positive electrode active material, which includes:
a first lithium iron phosphate material and a second lithium iron phosphate material. When the percentage of cumulative volume distribution of the first lithium iron phosphate material is at 50%, the corresponding particle size is D¹ᵥ50 μm. When the percentage of cumulative volume distribution of the second lithium iron phosphate material is at 50%, the corresponding particle size is D²ᵥ50 μm. D¹ᵥ50 is in the range of 0.3-0.95, and D²ᵥ50 is in the range of 1.0-3.5. When the percentages of cumulative volume distribution of the lithium iron phosphate positive electrode active material are at 90%, 10%, and 50%, the corresponding particle sizes are respectively Dᵥ90 μm, Dᵥ10 μm, and Dᵥ50 μm. When the percentage of cumulative number distribution of the lithium iron phosphate positive electrode active material is at 50%, the corresponding particle size is Dₙ50 μm. The particle sizes of the lithium iron phosphate positive electrode active material meet the following relation formula:

$$0.16 \leq \frac{{D}_{v} 90 - {D}_{v} 10}{{D}_{v} 50} + {D}_{v} 50 \times {D}_{n} 50 \leq 31.1 .$$

In the present disclosure, two lithium iron phosphate materials having different particle sizes are used, and the particle size of the obtained positive electrode active material is made to meet a certain relation formula, to obtain that the positive electrode active material has a high compaction density (2.55 g/cm³ or higher). This promotes the improvement of the energy density of a battery prepared with this positive electrode active material. In addition, the battery prepared with this positive electrode active material has excellent electrochemical performances, particularly the cycle performance.

In some embodiments of the present disclosure, the maximum compaction density of the lithium iron phosphate positive electrode active material is 2.55 g/cm³ or higher. In some embodiments of the present disclosure, the maximum compaction density is 2.55-2.85 g/cm³. It is to be understood that the maximum compaction density of a certain material mentioned in the present disclosure refers to the maximum compaction density obtained by testing the material with a powder compaction densitometer, or the maximum available compaction density of a positive electrode sheet prepared with this material. The maximum compaction density of the positive electrode sheet refers to the corresponding compaction density of the electrode sheet when the active material particles in the positive electrode sheet are crushed under a certain pressure.

The D¹ᵥ50 value of the first lithium iron phosphate material and D²ᵥ50 value of the second lithium iron phosphate material can be obtained from their respective laser particle size distribution diagrams. In an embodiment, the test instrument is a laser particle size analyzer (such as Malvern 3000). The test method can be found in GB/T 19077-2016/ISO 13320:2009 Particle size analysis-Laser diffraction methods. When the cumulative volume distribution percentage of a material is at 50%, the corresponding particle size is referred to as median particle size of the material. Similarly, the values of the particle size Dₙ50, Dᵥ90, Dᵥ10, and Dᵥ50 of the lithium iron phosphate positive electrode active material can be obtained by determining the laser particle size distribution of a mixed powder obtained by mixing the first lithium iron phosphate material and the second lithium iron phosphate material.

In the present disclosure, D¹ᵥ50<D²ᵥ50. When D¹ᵥ50 of the lithium iron phosphate material is small, the lithium ion diffusion path is relatively short, and the prepared battery has a good electrical performance. When D²ᵥ50 of the lithium iron phosphate material is large, the compaction density of the positive electrode active material can be increased. When the particle sizes Dᵥ50 of the two materials are in the above ranges, it allows that the two lithium iron phosphate materials can form a dense mass by mixing the two materials, thus improving the compaction density of the obtained positive electrode active material without compromising the cycle performance of the battery.

In some embodiments of the present disclosure, D¹ᵥ50 of the first lithium iron phosphate material is in the range of 0.4-0.85, and D²ᵥ50 of the second lithium iron phosphate material is in the range of 1.2-3.0. In this case, the use of the positive electrode active material obtained by mixing the two lithium iron phosphate materials can obtain the high compaction density of the positive electrode sheet and the good electrochemical performance of the battery.

In some embodiments of the present disclosure,

$$\frac{{D}_{v} 90 - {D}_{v} 10}{{D}_{v} 50} + {D}_{v} 50 \times {D}_{n} 50$$

is in the range of 0.2-31. In some embodiments,

$$\frac{{D}_{v} 90 - {D}_{v} 10}{{D}_{v} 50} + {D}_{v} 50 \times {D}_{n} 50$$

In some embodiments of the present disclosure, Dᵥ50×Dₙ50 is in the range of 0.05-4.9. In this case, the compaction density of the positive electrode active material is high, and the electrochemical performance is excellent. In some embodiments, Dᵥ50×Dₙ50 may be in the range of 0.1-4.5. In some embodiments, Dᵥ50×Dᵥ50 may be in the range of 0.6-4.

In some embodiments of the present disclosure, Dᵥ50 of the lithium iron phosphate positive electrode active material is in the range of 0.25-3.5. Dᵥ50 represents the corresponding particle size when the cumulative volume distribution percentage of the positive electrode active material is at 50%. If the Dᵥ50 value of the positive electrode active material obtained after mixing is in the above range, it allows that the positive electrode active material particles can be properly piled up, the polarization intensity of the electrode sheet is low, the lithium ion transmission speed is high during the cycle process of the battery, and the energy density of the secondary battery is high.

In the present disclosure, the mixing weight ratio of the first lithium iron phosphate material and the second lithium iron phosphate material is not particularly limited, as long as it allows that the particle size of the positive electrode active material formed by mixing the two materials meet the above relation formula. In some embodiments of the present disclosure, the mixing weight ratio of the first lithium iron phosphate material and the second lithium iron phosphate material is in the range of 1:(1-9), and further in the range of 1:(1-4). In this case, the positive electrode active material formed by mixing the two lithium iron phosphate materials can well allow the high compaction density of the electrode sheet and the good cycle performance of the battery.

In some embodiments of the present disclosure, the first lithium iron phosphate material has a carbon coating layer on the surface and/or the second lithium iron phosphate material has a carbon coating layer on the surface. The carbon coating layer can be obtained by sequentially sanding, spray drying, and sintering a mixed slurry of a phosphorus source, an iron source, a lithium source, and a carbon source. In the present disclosure, the preparation method of the two lithium iron phosphate materials is not limited. The presence of the carbon coating layer allows the first and the second lithium iron phosphate material to have good electrical conductivity, and less side reactions with the electrolyte solution. The positive electrode active material obtained by mixing the two materials has a good electrical conductivity, and the cycle performance of the battery is good.

According to the lithium iron phosphate positive electrode active material provided in the first aspect of the present disclosure, by mixing two lithium iron phosphate materials meeting the requirements of the particle size parameters, it allows that the obtained positive electrode active material has a high compaction density, and a battery prepared with the positive electrode active material has a good cycle performance and a good rate performance. The preparation method has simple process, and is easy to operate, thus being suitable for use in the large-scale production.

In a second aspect, the present disclosure provides a positive electrode sheet. The positive electrode sheet includes a lithium iron phosphate positive electrode active material according to the first aspect of the present disclosure.

In some embodiments of the present disclosure, the positive electrode sheet includes a positive electrode current collector and a positive electrode active material layer arranged/disposed on a surface of the positive electrode current collector. The positive electrode active material layer includes the lithium iron phosphate positive electrode active material, a binder, and a conductive agent.

The maximum compaction density of the positive electrode sheet is 2.55 g/cm³ or higher. In some embodiments, the maximum compaction density is 2.55-2.85 g/cm³.

In some embodiments of the present disclosure, the positive electrode active material layer is formed by coating a positive electrode paste including the lithium iron phosphate positive electrode active material, the conductive agent, the binder, and a solvent on the positive electrode current collector. The solvent can be one or more of N-methylpyrrolidone (NMP), acetone, and dimethyl acetamide (DMAC). The positive electrode current collector includes any one of an aluminum foil, a carbon-coated aluminum foil and a perforated aluminum foil. The conductive agent includes, but is not limited to, one or more of carbon nanotubes, graphene carbon black, carbon fiber, and the like. The binder includes, but is not limited to, one or more of polyvinylidene fluoride (PVDF), polytetrafluoroethylene (PTFE), polyvinyl alcohol (PVA), styrene-butadiene rubber (SBR), polyacrylic acid (PAA), polyacrylate, polyacrylonitrile (PAN), sodium carboxymethyl cellulose (CMC), and sodium alginate.

In a third aspect, the present disclosure provides a lithium ion battery. The lithium ion battery includes a positive electrode sheet according to the second aspect of the present disclosure.

In some embodiments of the present disclosure, the lithium ion battery further includes a negative electrode sheet, an electrolyte solution, and a separator located between the positive electrode sheet and the negative electrode sheet.

The lithium ion battery using the positive electrode sheet has a high energy density and an excellent cycle performance.

In the following, the technical solution of the present disclosure will be described in combination with embodiments.

### Example 1

A method for preparing a lithium iron phosphate positive electrode active material includes the following steps:

A first lithium iron phosphate material LFP-1 was used, where when the cumulative volume distribution percentage was at 50%, the corresponding particle size was determined to be 0.56 μm, that is, D¹ᵥ50 was 0.56.

A second lithium iron phosphate material LFP-2 was used, where when the cumulative volume distribution percentage was at 50%, the corresponding particle size was determined to be 1.85 μm, that is, D²ᵥ50 was 1.85.

The LFP-1 material and the LFP-2 material were mixed at a weight ratio of 2:8, to obtain a lithium iron phosphate positive electrode active material LFP-3. When the cumulative volume distribution percentages of the LFP-3 material were at 10%, 50%, and 90%, the corresponding particle sizes were respectively 0.31 μm, 0.74 μm, and 4.97 μm (that is, Dᵥ10 was 0.31, Dᵥ50 was 0.74, and Dᵥ90 was 4.97). When the cumulative number distribution percentage was at 50%, the corresponding particle size is 0.84 μm (that is, Dᵥ50 was 0.84). As calculated,

$$\frac{{D}_{v} 90 - {D}_{v} 10}{{D}_{v} 50} + {D}_{v} 50 \times {D}_{n} 50 = 6.92 ,$$

and Dᵥ50×Dₙ50=0.6216.

The positive electrode active material LFP-3 was prepared into a positive electrode sheet, by mixing the LFP-3 material with a binder (e.g., polyvinylidene fluoride (PVDF)) and conductive carbon black at a weight ratio of 85:5:10, adding an appropriate amount of N-methyl pyrrolidone (NMP), and mixing uniformly, to obtain a positive electrode paste. The positive electrode paste was coated on two sides of a carbon-coated aluminum foil, and dried, to obtain a positive electrode sheet. The maximum compaction density of the positive electrode sheet without particle breakage was determined. The maximum compaction density of the positive electrode sheet was determined to be 2.63 g/cm³.

Preparation of pouch lithium ion battery: The positive electrode sheet prepared with the positive electrode active material LFP-3 in Example 1 was used as a positive electrode. A graphite electrode sheet was used as a negative electrode. A polypropylene film was used as a separator. A solution containing 1.0 mol/L LiPF₆ in ethylene carbonate (EC): dimethyl carbonate (DMC)=1:1 (volume ratio) was used as an electrolyte solution. After assembly, a pouch battery was obtained.

### Example 2

A method for preparing a lithium iron phosphate positive electrode active material includes the following steps:

A first lithium iron phosphate material LFP-1 was used, and D¹ᵥ50 (the concept was as described in Example 1, and would not be repeated here, hereinafter) was determined to be 0.65.

A second lithium iron phosphate material LFP-2 was used, and D²ᵥ50 (the concept was as described in Example 1, and would not be repeated here, hereinafter) was determined to be 2.5.

The LFP-1 material and the LFP-2 material were mixed at a weight ratio of 3:7, to obtain a lithium iron phosphate positive electrode active material LFP-3. For the LFP-3 material, Dᵥ10 was 0.19, Dᵥ50 was 1.15, Dₙ90 was 4.97, Dₙ50 was 1.89,

$$\frac{{D}_{v} 90 - {D}_{v} 10}{{D}_{v} 50} + {D}_{v} 50 \times {D}_{n} 50 = 6.33 ,$$

and Dᵥ50×Dₙ50=2.1735.

Following the method described in Example 1, the positive electrode active material LFP-3 obtained in Example 2 was prepared into a positive electrode sheet, and assembled into a pouch battery. The maximum compaction density of the positive electrode sheet in Example 2 was determined to be 2.67 g/cm³.

### Example 3

A method for preparing a lithium iron phosphate positive electrode active material includes the following steps:

A first lithium iron phosphate material LFP-1 was used, and D¹ᵥ50 was determined to be 0.92.

A second lithium iron phosphate material LFP-2 was used, and D²ᵥ50 was determined to be 3.43.

The LFP-1 material and the LFP-2 material were mixed at a weight ratio of 4:6, to obtain a lithium iron phosphate positive electrode active material LFP-3. For the LFP-3 material, Dᵥ10 was 0.31, Dᵥ50 was 0.89, Dᵥ90 was 6.67, Dᵥ50 was 4.31,

$$\frac{{D}_{v} 90 - {D}_{v} 10}{{D}_{v} 50} + {D}_{v} 50 \times {D}_{n} 50 = 10.98 ,$$

and Dᵥ50×Dₙ50=3.8359.

Following the method described in Example 1, the positive electrode active material LFP-3 obtained in Example 3 was prepared into a positive electrode sheet, and assembled into a pouch battery. The maximum compaction density of the positive electrode sheet in Example 3 was determined to be 2.60 g/cm³.

### Example 4

A method for preparing a lithium iron phosphate positive electrode active material includes the following steps:

A first lithium iron phosphate material LFP-1 was used, and D¹ᵥ50 was determined to be 0.15.

A second lithium iron phosphate material LFP-2 was used, and D²ᵥ50 was determined to be 1.15.

The LFP-1 material and the LFP-2 material were mixed at a weight ratio of 3:7, to obtain a lithium iron phosphate positive electrode active material LFP-3. For the LFP-3 material, Dᵥ10 was 0.17, Dᵥ50 was 0.25, Dᵥ90 was 6.7, Dₙ50 was 2.77, Dᵥ90−Dᵥ10/Dᵥ50+Dᵥ50×Dₙ50=26.81, and Dᵥ50×Dₙ50=0.6925.

Following the method described in Example 1, the positive electrode active material LFP-3 obtained in Example 4 was prepared into a positive electrode sheet, and assembled into a pouch battery. The maximum compaction density of the positive electrode sheet in Example 4 was determined to be 2.79 g/cm³.

### Example 5

A method for preparing a lithium iron phosphate positive electrode active material includes the following steps:

A first lithium iron phosphate material LFP-1 was used, and D¹ᵥ50 was determined to be 0.92.

A second lithium iron phosphate material LFP-2 was used, and D²ᵥ50 was determined to be 1.23.

The LFP-1 material and the LFP-2 material were mixed at a weight ratio of 1:9, to obtain a lithium iron phosphate positive electrode active material LFP-3. For the LFP-3 material, Dᵥ10 was 0.25, Dᵥ50 was 0.67, Dᵥ90 was 5.79, Dₙ50 was 1.32,

$$\frac{{D}_{v} 90 - {D}_{v} 10}{{D}_{v} 50} + {D}_{v} 50 \times {D}_{n} 50 = 9.15 ,$$

and Dᵥ50×Dₙ50=0.8844.

Following the method described in Example 1, the positive electrode active material LFP-3 obtained in Example 5 was prepared into a positive electrode sheet, and assembled into a pouch battery. The maximum compaction density of the positive electrode sheet in Example 5 was determined to be 2.83 g/cm³.

### Example 6

A method for preparing a lithium iron phosphate positive electrode active material includes the following steps:

A first lithium iron phosphate material LFP-1 was used, and D¹ᵥ50 was determined to be 0.90.

A second lithium iron phosphate material LFP-2 was used, and D²ᵥ50 was determined to be 1.12.

The LFP-1 material and the LFP-2 material were mixed at a weight ratio of 1:9, to obtain a lithium iron phosphate positive electrode active material LFP-3. For the LFP-3 material, Dᵥ10 was 0.8, Dᵥ50 was 3.5, Dᵥ90 was 4.23, Dᵥ50 was 0.23,

$$\frac{{D}_{v} 90 - {D}_{v} 10}{{D}_{v} 50} + {D}_{v} 50 \times {D}_{n} 50 = 1.785 ,$$

and Dᵥ50×Dₙ50=0.805.

Following the method described in Example 1, the positive electrode active material LFP-3 obtained in Example 6 was prepared into a positive electrode sheet, and assembled into a pouch battery. The maximum compaction density of the positive electrode sheet in Example 6 was determined to be 2.62 g/cm³.

To highlight the beneficial effects of the present disclosure, the following comparative examples are provided.

### Comparative Example 1

A method for preparing a lithium iron phosphate positive electrode active material includes the following steps:

A first lithium iron phosphate material LFP-1 was used, and D¹ᵥ50 was determined to be 0.95.

A second lithium iron phosphate material LFP-2 was used, and D²ᵥ50 was determined to be 3.45.

The LFP-1 material and the LFP-2 material were mixed at a weight ratio of 1:9, to obtain a lithium iron phosphate positive electrode active material LFP-3. For the LFP-3 material, Dᵥ10 was 0.94, Dᵥ50 was 4.55, Dᵥ90 was 7.89, Dᵥ50 was 6.78, and

$$\frac{{D}_{v} 90 - {D}_{v} 10}{{D}_{v} 50} + {D}_{5} 50 \times {D}_{n} 50 = 32.38 ,$$

which fell outside the range of 0.16-31.1 defined in the present disclosure.

Following the method described in Example 1, the positive electrode active material LFP-3 obtained in Comparative Example 1 was prepared into a positive electrode sheet, and assembled into a pouch battery. The maximum compaction density of the positive electrode sheet in Comparative Example 1 was determined to be 2.49 g/cm³.

### Comparative Example 2

A method for preparing a lithium iron phosphate positive electrode active material includes the following steps:

A first lithium iron phosphate material LFP-1 was used, and D¹ᵥ50 was determined to be 1.24, which fell outside the range of 0.3-0.95 defined in the present disclosure.

A second lithium iron phosphate material LFP-2 was used, and D²ᵥ50 was determined to be 4.2, which fell outside the range of 1.0-3.5 defined in the present disclosure.

The LFP-1 material and the LFP-2 material were mixed at a certain weight ratio, to obtain a lithium iron phosphate positive electrode active material LFP-3. For the LFP-3 material, Dᵥ10 was 0.87, Dᵥ50 was 3.21, Dᵥ90 was 8.32, Dᵥ50 was 3.65, and

$$\frac{{D}_{v} 90 - {D}_{v} 10}{{D}_{v} 50} + {D}_{v} 50 \times {D}_{n} 50 = 14.04 .$$

Following the method described in Example 1, the positive electrode active material LFP-3 obtained in Comparative Example 2 was prepared into a positive electrode sheet, and assembled into a pouch battery. The maximum compaction density of the positive electrode sheet in Comparative Example 2 was determined to be 2.35 g/cm³.

To provide powerful support for the beneficial effects of the present disclosure, the pouch battery of each example and comparative example were tested for the following electrochemical performance.
1) Cycle performance: Each pouch battery was subjected to charge-discharge cycle test at 0.5 C/0.5 C at 25° C. The voltage range was 2.0-3.8 V. During charging, the battery was charged to 3.8 V at a constant current of 0.5 C and then charged to a cut-off current of 0.05 C at a constant voltage. The first-cycle coulombic efficiency and the capacity retention rate after 1000 charge-discharge cycles were tested.
2) Discharge capacity per gram of positive electrode active material: In a voltage range of 2.0-3.8 V, the positive electrode active material LFP-3 of each example and comparative example was charged to 3.8 V at a constant current LFP-3 of 0.1 C, and then to a cut-off current of 0.05 C at a constant voltage. Then, the positive electrode active material was discharged to 2.0 V at a constant current of 0.1 C. The charge and discharge process was repeated 3 times. The discharge capacity of the 3rd time was recorded as Co, Co dividing the weight of LFP-3 in each example and comparative example was the capacity per gram of LFP-3.

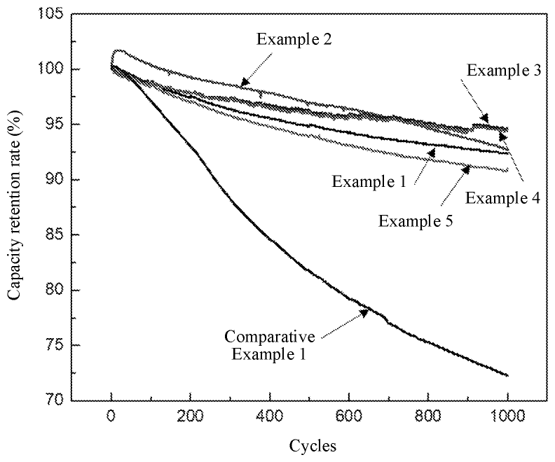

FIG. 1 shows a cycle performance curve of each pouch battery in Embodiments 1 to 5 and Comparative Embodiment 1. The first-cycle coulombic efficiency, the capacity retention rate after 1000 cycles, and other data of the batteries of each example and comparative example are summarized in Table 1 below.

TABLE 1

| | First-cycle coulombic | Discharge capacity | Capacity retention rate |
|---|---|---|---|
| Test item | efficiency (%) | per gram (mAh/g) | after 1000 cycles (%) |
| Example 1 | 98.6 | 149 | 93.8 |
| Example 2 | 98.6 | 152 | 92.5 |
| Example 3 | 98.9 | 154 | 94.6 |
| Example 4 | 98.7 | 153 | 94.7 |
| Example 5 | 99.0 | 157 | 94.6 |
| Example 6 | 98.2 | 148 | 92.1 |
| Comparative Example 1 | 90.1 | 121 | 65.1 |
| Comparative Example 2 | 87.9 | 137 | 74.3 |

As can be seen from FIG. 1 and Table 1, the positive electrode active material prepared by the method provided in the present disclosure has higher compaction density, and the battery prepared therewith has excellent electrochemical performances. For example, the first-cycle coulombic efficiency can be greater than 96%, the positive electrode has a high capacity per gram, and the capacity retention rate after 1000 cycles is still above 90%. In contrast, the relation formula of particle size of the positive electrode active material in Comparative Example 1 falls outside the range defined in the present disclosure. Consequently, although the compaction density of the positive electrode sheet is close to 2.5 g/cm³, it is still lower than the compaction density of the positive electrode in the present disclosure. Moreover, the first-cycle coulombic efficiency and cycle performance of the battery in Comparative Examples 1 are poor, and far inferior to the battery according to the present disclosure. In Comparative Embodiment 2, although the relation formula of particle size of the positive electrode active material falls within the range defined in the present disclosure, the median particle size of the two raw materials forming the positive active material are not within the range required the present disclosure. Therefore, the compaction density of the positive electrode sheet is low, and the cycle performance of the battery is poor.

The foregoing embodiments show only several implementations of the present disclosure and are described in detail, which, however, are not to be construed as a limitation to the scope of the present disclosure. It is to be understood that several variations and improvements can be made by those of ordinary skill in the art without departing from the idea of the present disclosure, which are all contemplated in the protection scope of the present disclosure. Therefore, the protection scope of the present disclosure shall be defined by the appended claims.

What is claimed is:

1. A lithium iron phosphate positive electrode active material, comprising:
a first lithium iron phosphate material and a second lithium iron phosphate material, wherein: a particle size of the first lithium iron phosphate material is D¹ᵥ50 μm at 50% cumulative volume distribution of the first lithium iron phosphate material, a particle size of the second lithium iron phosphate material is D²ᵥ50 μm at 50% cumulative volume distribution of the second lithium iron phosphate material, D¹ᵥ50 is in a range of 0.3-0.95, and D²ᵥ50 is in a range of 1.0-3.5;
particle sizes of the lithium iron phosphate positive electrode active material are Dᵥ90 μm, Dᵥ10 μm, and Dᵥ50 μm respectively at 90%, 10%, and 50% cumulative volume distribution of the lithium iron phosphate positive electrode active material;
a particle size of the lithium iron phosphate positive electrode active material is Dₙ50 μm at 50% cumulative number distribution of the lithium iron phosphate positive electrode active material; and
$${D}_{v} 90 , {D}_{v} 10 , {D}_{v} 50 , and \\ {D}_{n} 50 meet : 0.16 \leq \frac{{D}_{v} 90 - {D}_{v} 10}{{D}_{v} 50} + {D}_{v} 50 \times {D}_{n} 50 \leq 31.1 .$$

2. The lithium iron phosphate positive electrode active material according to claim 1, wherein a maximum compaction density of the lithium iron phosphate positive electrode active material is in a range of 2.55-2.85 g/cm³.

3. The lithium iron phosphate positive electrode active material according to claim 1, wherein D¹ᵥ50 of the first lithium iron phosphate material is in the range of 0.4-0.85, and D²ᵥ50 of the second lithium iron phosphate material is in the range of 1.2-3.0.

4. The lithium iron phosphate positive electrode active material according to claim 1, wherein Dᵥ90, Dᵥ10, Dᵥ50, and Dᵥ50 meet:
$$0.2 \leq \frac{{D}_{v} 90 - {D}_{v} 10}{{D}_{v} 50} + {D}_{v} 50 \times {D}_{n} 50 \leq 31.$$

5. The lithium iron phosphate positive electrode active material according to claim 1, wherein Dᵥ50×Dᵥ50 is in a range of 0.05-4.9.

6. The lithium iron phosphate positive electrode active material according to claim 1, wherein Dᵥ50 is in a range of 0.25-3.5.

7. The lithium iron phosphate positive electrode active material according to claim 1, wherein a weight ratio of the first lithium iron phosphate material and the second lithium iron phosphate material is in a range of 1:(1-9).

8. The lithium iron phosphate positive electrode active material according to claim 1, wherein at least one surface of the first lithium iron phosphate material and the second lithium iron phosphate material has a carbon coating layer.

9. A positive electrode sheet, comprising a lithium iron phosphate positive electrode active material, wherein the lithium iron phosphate positive electrode active material comprises:
a first lithium iron phosphate material and a second lithium iron phosphate material, wherein:
a particle size of the first lithium iron phosphate material is D¹ᵥ50 μm at 50% cumulative volume distribution of the first lithium iron phosphate material, a particle size of the second lithium iron phosphate material is D²ᵥ50 μm at 50% cumulative volume distribution of the second lithium iron phosphate material, D¹ᵥ50 is in a range of 0.3-0.95, and D²ᵥ50 is in a range of 1.0-3.5;
particle sizes of the lithium iron phosphate positive electrode active material are respectively Dᵥ90 μm, Dᵥ10 μm, and Dᵥ50 μm at 90%, 10%, and 50% cumulative volume distribution of the lithium iron phosphate positive electrode active material;
a particle size of the lithium iron phosphate positive electrode active material is Dₙ50 μm at 50% cumulative number distribution of the lithium iron phosphate positive electrode active material; and
Dᵥ90, Dᵥ10, Dᵥ50, and Dₙ50 meet:
$$0.16 \leq \frac{{D}_{v} 90 - {D}_{v} 10}{{D}_{v} 50} + {D}_{v} 50 \times {D}_{n} 50 \leq 31.1 .$$

10. The positive electrode sheet according to claim 9, further comprising a positive electrode current collector and a positive electrode active material layer disposed on a surface of the positive electrode current collector, wherein the positive electrode active material layer comprises the lithium iron phosphate positive electrode active material, a binder, and a conductive agent.

11. The positive electrode sheet according to claim 10, wherein the positive electrode active material layer is formed by coating a positive electrode paste comprising the lithium iron phosphate positive electrode active material, the conductive agent, the binder, and a solvent on the positive electrode current collector.

12. The positive electrode sheet according to claim 10, wherein a maximum compaction density of the lithium iron phosphate positive electrode active material is in a range of 2.55-2.85 g/cm³.

13. The positive electrode sheet according to claim 10, wherein D¹ᵥ50 of the first lithium iron phosphate material is in the range of 0.4-0.85, and D²ᵥ50 of the second lithium iron phosphate material is in the range of 1.2-3.0.

14. The positive electrode sheet according to claim 10, wherein Dᵥ90, D_{V}10, Dᵥ50, and Dₙ50 meet:
$$0.2 \leq \frac{{D}_{v} 90 - {D}_{v} 10}{{D}_{v} 50} + {D}_{v} 50 \times {D}_{n} 50 \leq 31.$$

15. The positive electrode sheet according to claim 10, wherein Dᵥ50×Dᵥ50 is in a range of 0.05-4.9.

16. The positive electrode sheet according to claim 10, wherein Dᵥ50 is in a range of 0.25-3.5.

17. The positive electrode sheet according to claim 10, wherein a weight ratio of the first lithium iron phosphate material and the second lithium iron phosphate material is in a range of 1:(1-9).

18. The positive electrode sheet according to claim 10, wherein at least one surface of the first lithium iron phosphate material and the second lithium iron phosphate material has a carbon coating layer.

19. A lithium ion battery, comprising a positive electrode sheet, wherein the positive electrode sheet comprises a lithium iron phosphate positive electrode active material, and the lithium iron phosphate positive electrode active material comprises:
a first lithium iron phosphate material and a second lithium iron phosphate material, wherein:
a particle size of the first lithium iron phosphate material is D¹ᵥ50 μm at 50% cumulative volume distribution of the first lithium iron phosphate material, a particle size of the second lithium iron phosphate material is D²ᵥ50 μm at 50% cumulative volume distribution of the second lithium iron phosphate material, D¹ᵥ50 is in a range of 0.3-0.95, and D²ᵥ50 is in a range of 1.0-3.5;
particle sizes of the lithium iron phosphate positive electrode active material are respectively Dᵥ90 μm, Dᵥ10 μm, and Dᵥ50 μm at 90%, 10%, and 50% cumulative volume distribution of the lithium iron phosphate positive electrode active material;
a particle size of the lithium iron phosphate positive electrode active material is Dₙ50 μm at 50% cumulative number distribution of the lithium iron phosphate positive electrode active material; and
Dᵥ90, Dᵥ10, Dᵥ50, and Dᵥ50 meet:
$$0.16 \leq \frac{{D}_{v} 90 - {D}_{v} 10}{{D}_{v} 50} + {D}_{v} 50 \times {D}_{n} 50 \leq 31.1 .$$

20. The lithium ion battery according to claim 19, further comprising a negative electrode sheet, an electrolyte solution, and a separator between the positive electrode sheet and the negative electrode sheet.
